(19) United States
(12) Patent Application Publication
(10) Pub. No.: US 2013/0243090 A1
(43) Pub. Date: Sep. 19, 2013

(54) Block-matching Motion Estimation Method and Apparatus

(71) Applicant: Yan Xin Li, Burlington (CA)

(72) Inventor: Yan Xin Li, Burlington (CA)

(73) Assignee: Yan Xin Li, Burlington (CA)

(21) Appl. No.: 13/418,344

(22) Filed: Mar. 13, 2012

(51) Int. Cl. H04N 7/26

(52) U.S. Cl. 375/240.16; 375/E07.108

(57) ABSTRACT

A method and an apparatus for block matching motion estimation are provided. The motion estimation process for selecting the best matching micro block (MB) in search window (SW) for the current micro block (curMB), is carried out a in a multi-step refinement process. All or subset of possible reference MBs (denoted as {refMB}) are selected from SW. Then {refMB} and curMB are transformed to simplified representations {refMBt} and curMBt. A plurality of MBs in set {refMBt} that best match curMBt are searched and found out. This process of transform-and-search is repeated. In each repeated time, the selected {refMB} will have the same motion vectors as that of those best matching MBs found last time; also in each repeated time, a more precise transform method will be used, and less number of best matching MB candidates will be found out. The final one best matching candidate will be found in this repeated transform-and-search refinement process.

### FIELD OF THE INVENTION

The invention relates generally to motion estimation and, more particularly, to a method and apparatus utilizing multi-step refinement motion estimation searching process t001o find the best matching reference micro block in search window for a current micro block.

### BACKGROUND OF THE INVENTION

Many video compression standards have been developed for visual communication applications, such as, for example, ISO/IEC MPEG-1, MPEG-2, MPEG-4, CCITT H.261, ITU-T H.263, ITU-T H.264, and Microsoft WMV9/VC-1. Block-matching motion estimation is widely applied in these motion-compensated video coding techniques/standards.

The block matching problem that this invention intends to address can be described as: Given one M×N size of source block of pixels and another block of LxK pixels which is larger (L>=N and K>=N) and used as search window, find the M×N sub-block in the search window that best matches the source block measured by matching criterion.

Usually the M×N source block is the current micro block (MB) in current frame and searching window is a block in a reference frame or a plurality of blocks in reference frames. From here on, the M×N source block will be referred as current micro block or curMB, and the micro block in search window (SW) will be referred as reference micro block, or refMB.

The matching criterion is typically the sum of the absolute differences (SAD):

$$SAD = {\sum }_{i = 1}^{M} {\sum }_{j = 1}^{N} \vert Xij - Yij \vert \qquad [ 001 ]$$

for a M×N micro block, where X ij is the value at pixel (i,j) of current MB, and Y ij is the value at pixel (i,j) of reference search window.

To find the best matching micro block in search window, we may use a method called full search (FS). FS method evaluates each one of the possible candidate MBs from the search window and selects the one that best matches the current MB.

However, the motion estimation is quite computational intensive and can consume up to 80% of the computational power of the encoder if the full search is used. Therefore, it is highly desirable to develop fast motion estimation algorithms without significantly affecting the visual quality of the image, which can be reproduced from the compressed image signal.

In order to reduce the computation and time load of the block matching motion estimation, many computationally efficient variants were developed.

Several fast search ME algorithms, such as New Three-Step Search [8], Four-Step Search [9], Diamond Search [10], Hexagon-Based Search [20], are proposed to reduce the computational complexity of FS algorithm. This category of algorithms try to approach the PSNR of FS algorithm by computing the SAD values for fewer search locations in a given search range.

Another category is called Low bit-depth matching (LBDM) based motion estimation methods. This category is closely related to this invention. It includes methods that use less bit depth representations of the input frames for block matching. This also leads to much simplified matching criteria. For example, an 8-bit SAD calculation requires a subtraction and absolute value operation as shown in [001], 1-bit matching only requires an exclusive-or (XOR) operation and is very suitable for hardware implementation.

Low bit-depth matching (LBDM) is based on the fact that the evaluation of SAD is computationally expensive for pixels of full intensity resolution. So LBDM first transform the current and reference frame to frames of low bit-depth pixels. Then, one of the conventional search strategies can be implemented to these frames. The matching function usually only computes the exclusive-or of a sequence of bits and adds the number of ones in the results.

Here is a list of the most commonly used LPDM algorithms:
The 1-bit transform (1BT) [3],
Multiplication-free 1-bit transform (MF-1BT) [5]
Multiplication-free 1-bit transform using one diamond kernel filter (MF-1BT-1 DK)
Constrained 1-bit transform (C-1BT) [4]
2-bit transform2 (2BT) [6]
Weighted Constrained One-Bit Transform (WC-1BT) [16]
Truncated gray-coded bit-plane matching (T-GCBPM) [2]
Truncated bit-plane matching (T-BPM) [7][11]
Low bit-depth matching with adaptive search range (LBDM-ASR) [15][17]
LPDM with diamond search and 1BT(LBDM-DS)[18]
LPDM with early termination (LPDM-ET) [13] [14].

Here is a brief explanation of each method listed above. Detailed description of each method can be found in the related references.

1BT: Video frames are initially converted to binary images using multi band-pass filtered video frames as adaptive threshold. Next, a Boolean EX-OR operation based matching criteria is utilized to find the matching block.

MF-1BT: It is similar to 1BT but uses a different kind of filter kernel that omits multiplication operations at multi-band-pass filtering stage and thus deduced computation costs. It provides similar motion estimation accuracy compared to 1BT, resulting in a lower transform cost.

MF-1BT-1 DK: It is similar to MF-1BT but uses a simplified filter kernel which needs only three add operations for each pixel instead of fifteen add operations used in MF-1BT. It provides similar motion estimation accuracy compared to MF-1BT.

C-1BT: First, an 1-bit plane is constructed in the same way as 1BT, MF-1BT or MF-1BT-1 DK, at the same time an additional constraint mask (CM) 1-bit plane is created to discriminate reliable pixels in 1BT based ME. The CM and 1BT bit planes are employed together to compute matching criterion. Additional cost of this method is quite low compared to 2BT. Furthermore, it provides better performance than 1BT and 2BT based methods.

2BT: An additional bit-plane is derived using local image features. Then, two bit-planes for each frame are employed together to compute matching criteria. It has higher accuracy compared to 1BT based ME. However, computational load of 2BT is higher than 1BT.

T-BPM: This method uses bit truncation by utilizing only a certain number of the most significant bits (MSB), by truncating the lower least significant bits (LSB), in order to reduce the computational load and memory usage.

T-GCBPM: The full-bit pixel is first converted to full-bit Gray code, then one or more LSBs are truncated to get truncated versions of Gray-coded bit-planes. The Gray code conversion is efficient to implement when using hardware, it has very low-complexity compared with 1BT and 2BT and provides better performance than 1BT, 2BT and TB-BPM.

LBDM-DS: Method to combine diamond search and 1BT to speed-up 1BT based ME. A predictive hexagonal search approach and partial distortion search method is combined with C-1BT based ME and it is shown that the significant reduction on computational load is possible with small amount of performance loss.

LPDM-ASR: A method to combine adaptive search range with low bit-depth methods. This method initially determines the search range for each block using a simple computation then, motion estimation is performed. Experiments have been show that this approach can provide up to 90% gain in computational load.

LPDM-ET: Methods to utilize special early termination approaches for low bit-depth matching based motion estimation.

The disadvantage of LBDM is that is has relatively low motion vector accuracy. This is caused by the fact that the low bit-depth version of image is a simplified and changed representation of the original full bit-depth one. The lower the bit-depth, the worse this problem.

Because it has low complexity and low motion vector accuracy, the LBDM approach is more suitable for consumer electronics equipment with low processing resources and limited power capabilities but without demanding for high video quality.

So a motion estimation approach that has the advantage of low complexity of LBDM method and at the same time can achieve high motion vector accuracy will be highly desirable.

Real-time video coding faces a big challenge from computational complexity, especially for mobile devices such as mobile phones and tablet PCs, which are of weak computational capability and short battery lifetime. For some scenarios, high video quality is needed and more computation resource can be allocated to meet the requirement. For some other scenarios, saving computation cost and battery life is more important than video quality. Also, conventional motion estimation method cannot adapt well to the varying computational requirements of video contents. It is highly desirable to have a complexity scalable motion estimation method that can offer a proper trade-off between motion accuracy and computation cost/power consumption.

### SUMMARY OF THE INVENTION

In view of the foregoing, the present invention provides a method and apparatus for block motion estimation using repeated multi-Step refinement process that can be implemented in both software and hardware. The algorithm is characterized by high accuracy, low complexity, and complexity scalability.

This invention provides the motion estimation method and apparatus for selecting the best matching micro block (MB) in search window (SW) for the current micro block (curMB), which is carried out a in a multi-step refinement process. All or subset of possible reference MBs are selected from SW to form a set denoted as {refMB}. Then {refMB} and curMB are transformed to simplified representations {refMBt} and curMBt. All or subset of MBs in set {refMBt} are searched and sorted according to a criterion suitable for curMBt and {refMBt}, a plurality of MBs that best match curMBt are selected out. This process of transform-and-search is repeated, each time the selected {refMB} will have the same motion vectors as that of those best matching MBs in {refMBt} found last time. Each time a more precise transform method will be used, and less number of best matching MB candidates will be found out, until the final one best matching candidate is found. A further step may follow to determine whether the best matching MB motion vector is accurate and whether another kind of motion estimation process needs to follow.

This invention provides the method to make the embodiments complexity scalable when the said embodiments use the method to implement motion estimation provided by this invention.

This invention also provides a method to evaluate the effectiveness of a certain transform method for the said motion estimation method provided by this invention.

### BRIEF DESCRIPTION OF DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram depicting an exemplary embodiment of a motion estimator in accordance with one or more aspects of the invention.

FIG. 2 is a flow diagram depicting an exemplary embodiment of a method and apparatus for block matching motion estimation in accordance with one or more aspects of the invention; and

FIG. 3 is a flow diagram depicting an exemplary embodiment of a method and apparatus for calculating parameter of Hit_rate for a functional in accordance with one or more aspects of the invention.

FIG. 4 is a flow diagram depicting an exemplary embodiment of a method and apparatus that implement Step4 of the motion estimation method provided by this invention.

FIG. 5 is a schematic diagram of a current MB (curMB) and search window (SW), including individual pixels;

FIG. 6 is a schematic diagram of all nine possible reference MBs in a search window (SW), including individual pixels;

FIG. 7 is a schematic diagram of transformed current MB (curMBt) and search window (SWt), including individual pixels;

FIG. 8 is a schematic diagram of transformed reference MB set {refMBt} using T-BPM with NTB=2, including individual pixels;

FIG. 9 is a schematic diagram of selected refMB set {refMB}, including individual pixels;

FIG. 10 is a schematic diagram of transformed refMB set {refMBt}, Using T-BPM with NTB=6, including individual pixels;

FIG. 11 is a schematic diagram of transformed current MB (curMBt), Using T-BPM with NTB=6, including individual pixels;

### DETAILED DESCRIPTION OF THE INVENTION

All following description assumes that SAD and criterion [001] is used as matching criterion. This is for example purpose, which should not unduly limit the scope of the claims. One of ordinary skill in the art would recognize many variations, alternatives, and modifications. Other criterion can be used instead of SAD for this invention.

All following description assumes that low bit-depth matching (LBDM) method is used to transform current micro block (curMB) and refMB in search window (SW) to simplified representations. This is only for example purpose, which should not unduly limit the scope of the claims. One of ordinary skill in the art would recognize many variations, alternatives, and modifications. Any other transform method can be used for the purpose to transform current micro block (curMB) and search window (SW) to simplified representations.

As shown in Table 1, when using low bit-depth matching (LBDM) method to transform and then do motion estimation, the peak signal to noise ratio (PSNR) of estimated picture to original picture is lower than that of using full search (FS) method. For some picture sequence, the PSNR drop is more than 2.6 db. This means that LBDM method cannot find all best matching micro block as FS method does.

TABLE 1
The average PSNR drop of predicted image using MF-1BT method
compared with using full search method, 100 frames, 352 × 288

| Image File | Mobile | Forman | Flower | Coastguard |
|---|---|---|---|---|
| Average PSNR | 1.016 | 2.604 | 0.805 | 0.791 |
| Drop | | | | |

This invention uses parameter Hit_rate to measure the effectiveness of how a specific LBDM method (1BT, 2BT, C-1BT, etc.) can find the best matching MB for a sequence of video frames. This invention provides the following method to determine Hit_rate for any given number Ncand (Ncand=1, 2, 3, etc):
(a) For every MB in every frame, use full search method to find best matching MB for the MB, store the motion vector of every best matching MB.
(b) For every MB in every frame, use the said LPDM method to find best Ncand of matching MBs using the same parameters (MB size, SW size, etc): first use the said LBDM method being evaluated to transform both the MB and SW to low bit-depth representation MBt and SWt, then use full search method to find Ncand number of the best matching MB in SWt for MBt.
(c) Compare and see if the Ncand number of best matching MBs include the one best matching block found using full search method in step (a). If it is the case, this MB is called a Hit_MB, which means the LPDM method has found the best matching MB.
(d) Count all Hit_MBs of all MB of the video frames and calculate Hit_rate according the following equation:

Hit_rate=(Number_of_Hit_MBs/Number_of_Total_MBs)×100 [002]

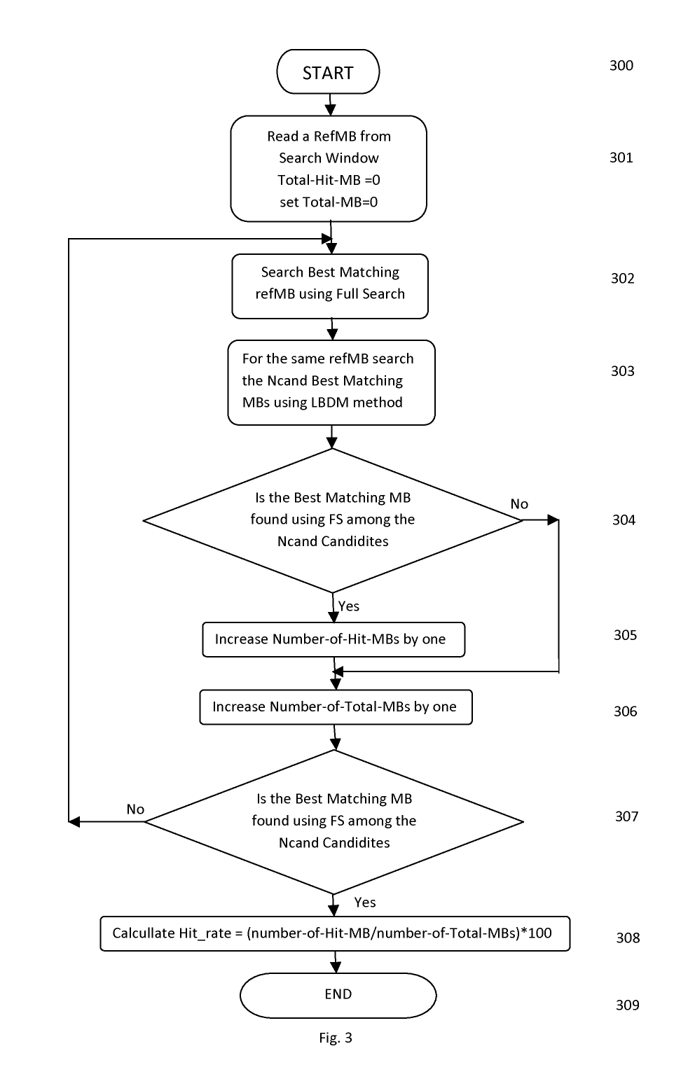

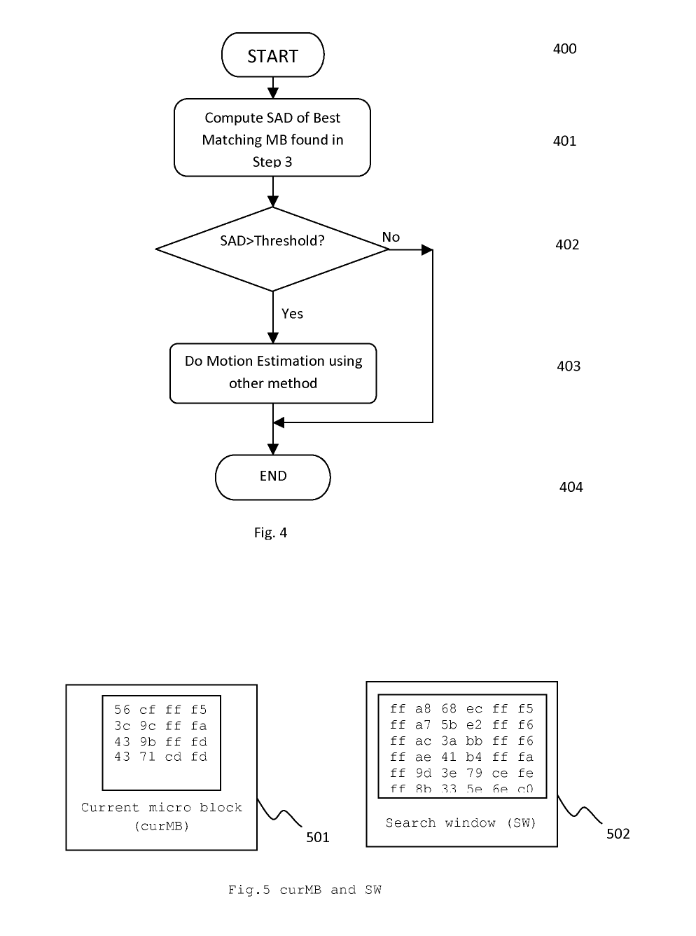

FIG. 3 is a flow diagram depicting an exemplary embodiment of a method and apparatus for calculating parameter of Hit_rate for a functional in accordance with one or more aspects of the invention. Procedure in FIG. 3 is for example purpose only, which should not unduly limit the scope of the claims. One of ordinary skill in the art would recognize many variations, alternatives, and modifications.

Table 2 shows the result for 4 typical video sequences. All are tested with 100 frames, MB size is 16×16, search window size is 31×31 and video size is 352×288. All tests use the previous frame as reference frame, and use MF-1BT method as the LBDM method.

The parameter Ncand means the number of candidates of best matching MB. When Ncand=1, it finds only one best matching MB, and this is the way how conventional LBDM method works. When Ncand=2, it will find the two most matching MB, that is the two blocks that has the smallest SADs. And so on for Ncand=3, 4, . . . etc.

TABLE 2
Hit_rate (%) using MF-1BT, MB size 16 × 16, search
window 31 × 31, 100 frames

| | Mobile | Forman | Flower | Coastguard |
|---|---|---|---|---|
| Ncand = 1 | 81.31 | 64.30 | 70.77 | 82.54 |
| Ncand = 2 | 92.99 | 78.56 | 79.46 | 95.53 |
| Ncand = 4 | 96.80 | 86.35 | 84.53 | 98.12 |
| Ncand = 8 | 97.95 | 90.61 | 88.57 | 98.99 |
| Ncand = 16 | 98.67 | 93.71 | 91.84 | 99.58 |
| Ncand = 32 | 99.18 | 95.83 | 94.31 | 99.76 |
| Ncand = 64 | 99.53 | 97.25 | 96.16 | 99.83 |
| Ncand = 128 | 99.69 | 98.28 | 97.52 | 99.93 |

The test result in Table-2 shows that when Ncand is set to 1, which is the case with conventional LBDM method, the Hit_rate is low. This means that the probability of finding best matching MB using conventional LBDM method is low. That is the reason why the PSNR value for conventional LBDM method is lower than FS method.

But when Ncand is big enough, for example when Ncand >=16, Hit_rate is much improved and the probability that the best matching MB is among the candidate is much higher. This discovery is the foundation of this invention.

This invention provides a method for motion estimation. The motion estimation method for selecting the best matching micro block (MB) in search window (SW) for the current micro block (curMB), comprising the steps of:
Step1: Select all or subset of MBs from SW to form a set {refMB}. If it is the first round of the repeated process, selection is based on a predefined method; otherwise the output motion vectors of Step3 of last round are used to select MBs from SW.
Step2: Use a transform method to transform the curMB and {refMB} to simplified representations curMBt and {refMBt}.
Step3: Search in {refMBt} and find predetermined number (Ncand) of MBs that best match curMBt by using a criterion that is suitable for the transform used in Step2. Output the motion vectors of these Ncand of best matching MBs to be used for the Step1 of next round. If Ncan=1, the final one best matching MB is determined and the process ends; otherwise, make the following changes, go to Step1 and repeat the process:
   (a) Use a different transform that can generate higher precision representations of curMB and {refMB} than last time, or just output the full bit-depth pixel without changing it, which can be thought of as a transform with the highest precision.
   (b) Use a smaller candidates number Ncand than that used in last round.

For some embodiments of this invention, Step4 is needed at ends of Step3 to improve motion vector accuracy with situations that the said repeated Step1 to 3 fails to find best matching MB. At he end of Step3 when the final one best matching MB is found, the process will go on to Step4.

Here is the description of Step4:
Step4: The sum of the absolute differences (SAD) value of the best matching MB will be compared to a threshold. If it is less than the threshold, the best-matching block is found and search process ends. Otherwise, it means Step1 to 4 fail to find the best matching micro block. Then a new round of motion estimation process other than that used in Step1 to 3 for finding the best matching MB in SW for the curMB is carried out. The motion estimation designer can choose any motion estimation algorithm other than the method described in Step1 to 3. After the best matching block is found in the said new round of motion estimation process, the whole best block matching selecting process ends.

Before the start of Step1, the following parameters need to be set for the said method and they can be predefined or configurable:
(1) How many times Step1 to 3 will be repeated.
(2) In Step1, whether to select all or subset MBs of all possible MBs from SW, and if subset of SW is selected, how to do it.
(3) In Step2, which transform method will be used.
(4) Ncand value for Step3.
(5) Whether to continue to Step4 at end of Step3.

The transform method used in Step2 may be but are not limited to one or more of the following methods. These are only example LPDM methods, which should not unduly limit the scope of the claims. One of ordinary skill in the art would recognize many variations, alternatives, and modifications. Any transform method that can transform the full bit length image to a simplified representation can be used.
The 1-bit transform (1BT) [3],
Multiplication-free 1-bit transform (MF-1BT) [5]
Multiplication-free 1-bit transform using one diamond kernel filter (MF-1BT-1 DK)
Constrained 1-bit transform (C-1BT) [4]
2-bit transform2 (2BT) [6]
Weighted Constrained One-Bit Transform (WC-1BT) [16]
Truncated gray-coded bit-plane matching (T-GCBPM) [2]
Truncated bit-plane matching (T-BPM) [7][11]
Low bit-depth matching with adaptive search range (LBDM-ASR) [15][17]
LPDM with diamond search and 1BT(LBDM-DS)[18]
LPDM with early termination (LPDM-ET) [13] [14].

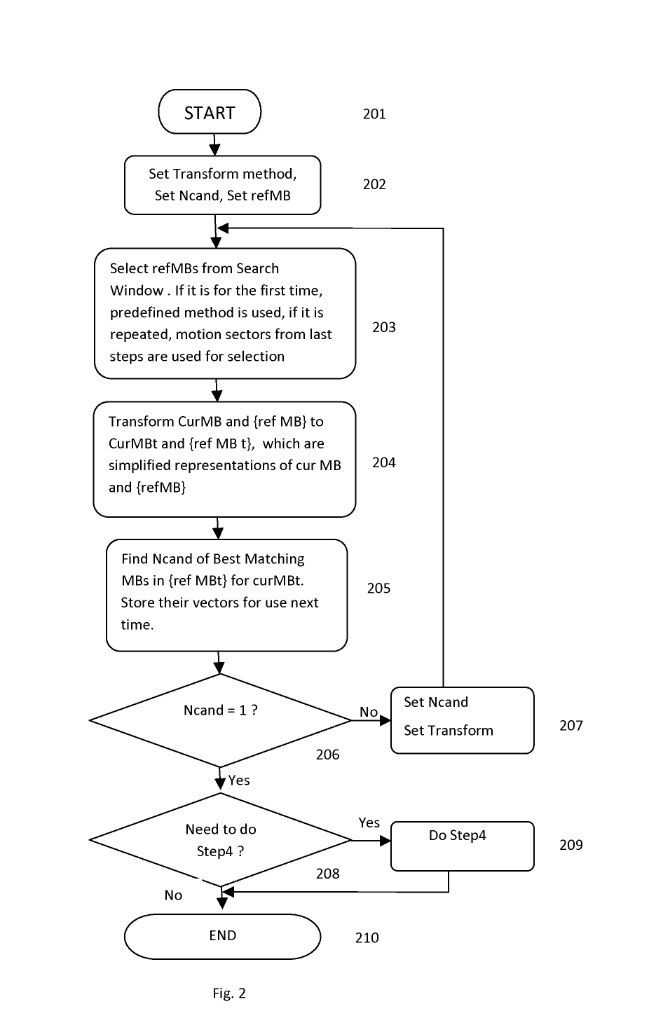

FIG. 2 is a flow diagram depicting an exemplary embodiment of a method and apparatus for block matching motion estimation using repeated multi-Step refinement process in accordance with one or more aspects of the invention; and

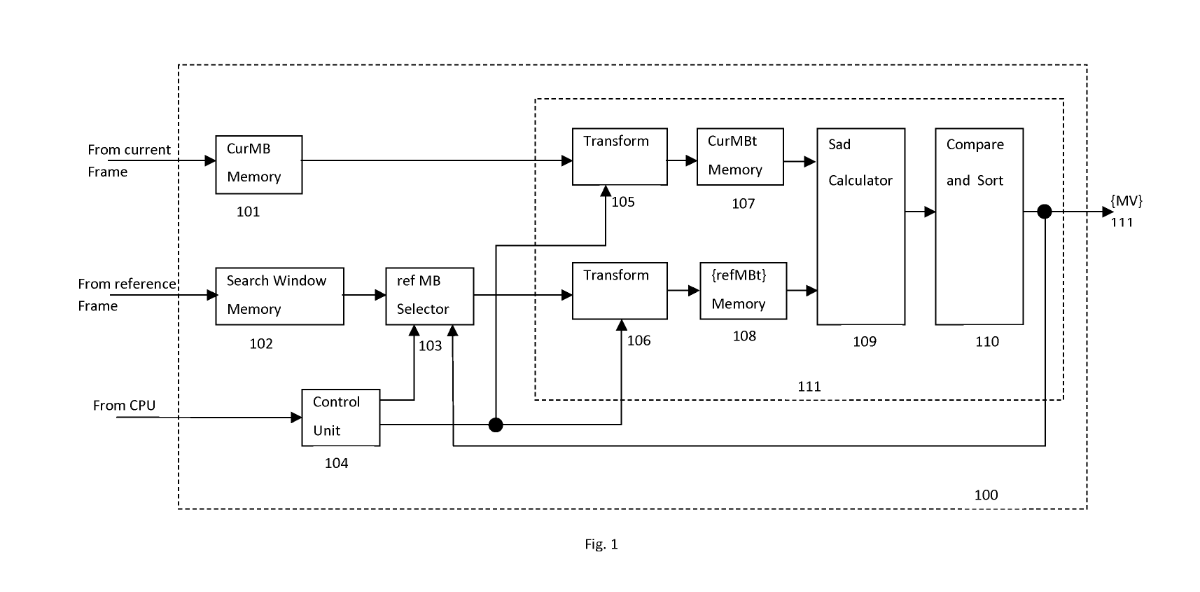

FIG. 1 is a block diagram depicting an exemplary embodiment of a motion estimator in accordance with one or more aspects of the invention.

Procedure in FIG. 1 and diagram in FIG. 2 are for example purpose only, which should not unduly limit the scope of the claims. One of ordinary skill in the art would recognize many variations, alternatives, and modifications.

There is no limitation to how many search windows (SW) are used in this invention. One or a plurality of search windows can be used for embodiments of this invention.

There is no limitation to how to select refMBs from SW in Step1. Any selection method appropriate can be used.

There is no limitation to the search method used in Step3. Any search method appropriate can be used.

The bigger the Ncand, the higher the Hit_rate and PSNR improvement. But the computation cost also increases as Ncand increases. With bigger Ncand, more memory and sorting computation is needed in Step2 and more number of SAD computations is needed for Step3. So it is the motion estimation system designer's responsibility to trade off between estimation accuracy and computation cost or hardware complexity. Table3 shows a list of percentage number of SAD values that need to be calculated with different Ncand settings, compared to that when using full search method. It assumes that the block size is of 16×16 and search window is of 31×31. So the total number of SAD need to be evaluated for full search is 31×31=1089.

TABLE 3
percentage of number of SAD calculated in Step3 compared to
full search with 33 × 33 search window size.

| | Ncand | | | | | | | |
|---|---|---|---|---|---|---|---|---|
| | 4 | 8 | 16 | 32 | 64 | 128 | 256 | 512 |
| Percentage (%) | 0.37 | 0.73 | 1.4 | 2.9 | 5.8 | 11.8 | 23.5 | 47.0 |

Table2 shows that even the Ncand is set to as high as 128, there is still probability that the best matching MB is not among the result candidates of Step3. This is why Step4 is needed for some embodiments of this invention to improve motion estimation accuracy. For some embodiments of this invention, the result best matching MB will be used as the matching of current MB, the search process will end at end of Step3 after the best matching MB is found, there is no implementation of Step4 in these embodiments.

For some embodiments of this invention, the Step4 is implemented and always enabled. For some other embodiments of this invention, Step4 is implemented but is configurable, and may be enabled in some occasion to achieve high vector accuracy, and disabled in other occasions to save power and computation cost.

There is no limitation of how to obtain the threshold used in Step4. It can be predefined or configurable. It can be SAD value of a reference MB with motion vector (0,0), or the SAD value of a predicted MB that is computed by using neighbor motion vector. These methods listed here are only for example purpose, which should not unduly limit the scope of the claims. One of ordinary skill in the art would recognize many variations, alternatives, and modifications.

There is no limitation to what kind of search method may be used in Step4.

To further explain this invention, an example named Example1 is described in the following text. It is only for example purpose, which should not unduly limit the scope of the claims. One of ordinary skill in the art would recognize many variations, alternatives, and modifications.

A current MB (curMB) of 4×4 size and a search window (SW) of 6×6 size are shown in FIG. 5. All pixels are 8-bit data. A reference MB (refMB) is a MB in SW that has the same size as curMB. Assume the refMB in the middle of SW has motion vector of (0,0), then the motion vectors of all nine possible reference MBs are listed as below:
(0,0), (1,0), (1,−1), (−1,0), (−1,−1), (−1,0), (−1,1), (0,1), (1,1).

The following criterion is used to calculate SAD

$$SAD = {\sum }_{i = 0}^{3} {\sum }_{j = 0}^{3} \vert Xij - Yij \vert \qquad [ 003 ]$$

Xij denotes intensity of pixel in curMB at position (i,j) and Yij denotes intensity of pixel in curMB at the same position.

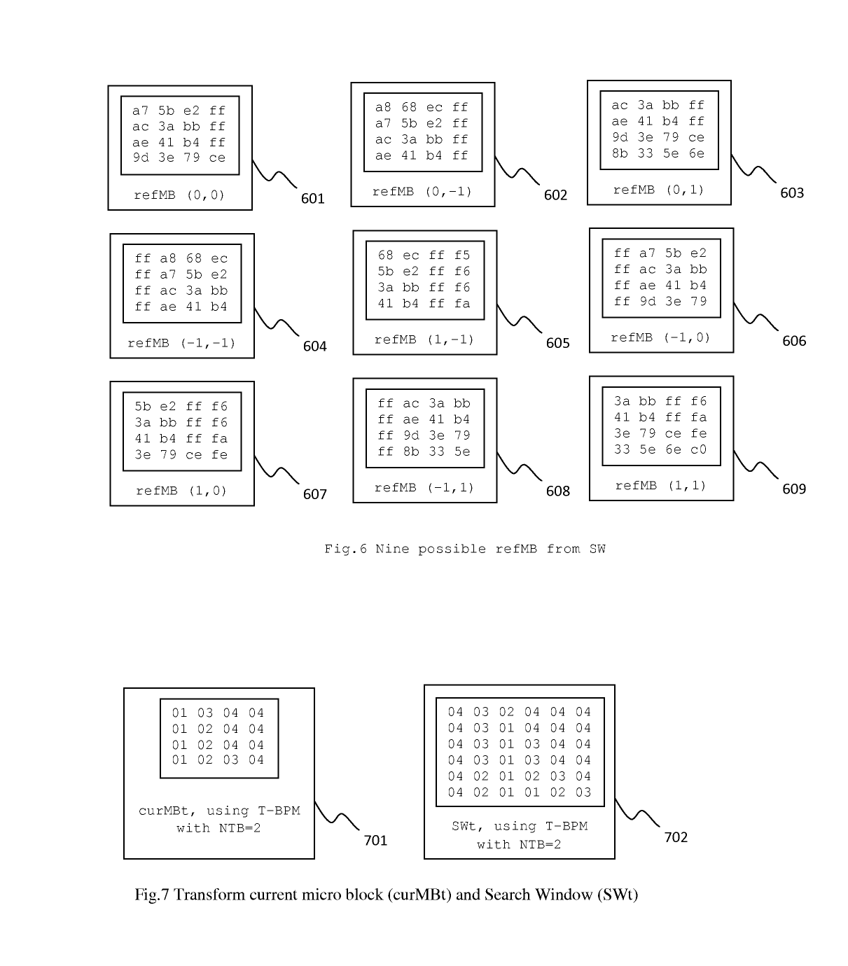

FIG. 6 shows all pixels and pixel intensity of all the nine possible reference MBs.

To use the method this invention provides, firstly all parameters needs to be set, as listed below:
(1) Step1 to 3 will be repeated 2 times.
(2) In Step1 of the first round, all MBs are selected from SW. For the second round in Step1, all MBs that have the same motion vector as that of output of Step3 of first round are selected from SW.
(3) In Step2 of the first round, T-BPM method with NTB=2 transform will be used, for the second round Step2, a more precise T-BPM method with NTB=6 transform will be used.
(4) In Step3, Ncand is set to 4 for the first round, and Ncand is set to 1 for second round.
(5) It will continue to Step4 at end of Step3 of the second round.

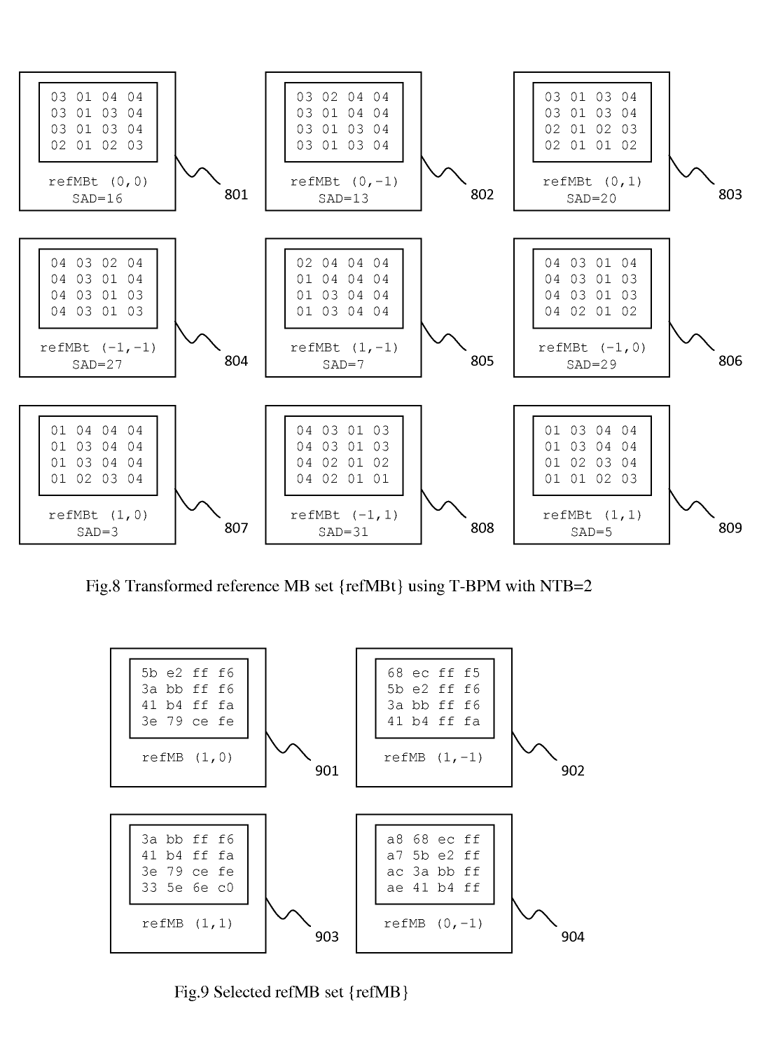

For the first round of the repeated process, in Step 1 all nine possible reference MBs are selected to form the set {refMB}, as shown in FIG. 6. In Step2, T-BPM method with NTB=3 transform is used to transform all nine MBs in {refMB} to simplified versions to form a set {refMBt}, as shown in FIG. 8. The curMB are also transformed to curMBt using the same transform method, as shown in FIG. 7. The T-BPM method with NTB=2 transform simply right shifts the pixel value six times to truncate the six LSBs (least significant bits). As Ncand is set to be four for the first round, in Step3 a search process is carried out to find the four most matching MBs in {refMBt} that best match curMBt. This invention has no limit to what kind of search method to use in this step. For this example, full search (FS) method is used. All SAD values of MBs in {refMBt} are calculated, compared and sorted. The motion vectors of the four MBs with smallest SAD values are output to be used for next round. Because Ncand is four and is bigger than one, the process will go on to Step1 for the second round.

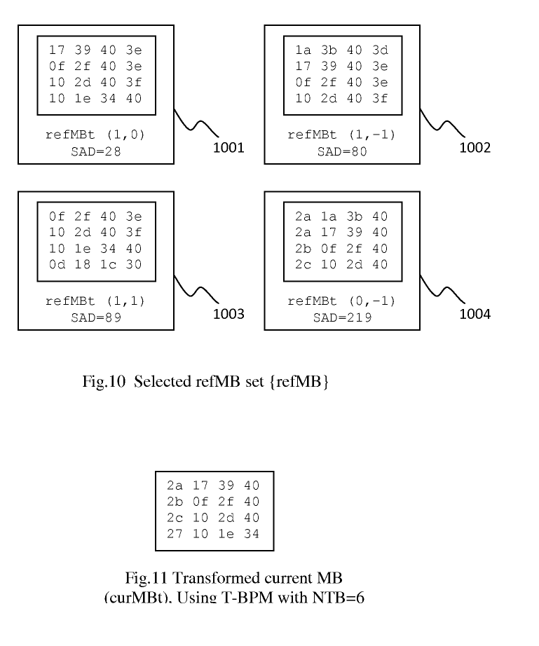

For the second round of the repeated process, in Step1 the output motion vectors of last Step3 are used to select four reference MBs from SW to form the set {refMB}. FIG. 9 shows {refMB}. In Step2, T-BPM method with NTB=6 transform is used which is more precise than that used in the first round. All the four MBs in {refMB} are transformed to simplified versions to form a set {refMBt}, as shown in FIG. 10. The curMB are also transformed to curMBt using the same transform method. The transformed curMBt are shown in FIG. 11. In Step3, a search process is carried out to find the one most matching MBs in {refMBt} that best match curMBt. For this example, full search (FS) method is used. All SAD values of MBs in {refMBt} are calculated, compared and sorted. The motion vectors of the MB with smallest SAD value are output, which is (1,0) for this example. Because Ncand is set to one and final best matching MB is found, the process will go on to Step4.

In Step4, the SAD of best matching MB is calculated and compared to a predefined threshold. If it is smaller than the threshold, motion estimation process ends. Otherwise, simply do a full search for current MB in SW and find the best matching MB to end the whole best matching MB selection process.

To show the effectiveness of this invention, the results of some tests are shown in Table 5. The tests are done with two different input image files and different Ncand settings. The MB size is 16×16. Search window size is 33×33 (measured in MB) and has 1089 reference MBs. One reference frame is used and it is always the previous frame. For every MB in current frame, a best matching refMB is searched in the SW of reference frame, firstly using full search and then the method of this invention. All best matching MBs in current frame are saved as a predicted frame. The PSNR is calculated for each predicted frame against the original frame. The PSNR of each frame of the two methods are compared and the average and maximum PSNR difference is listed in Table 5.

The parameters for the tests are set as below:
(1) Step1 to 3 will be repeated 2 times.
(2) For the first round in Step1, all MBs are Step1: Select all or subset of MBs from SW to form a set {refMB}. If it is the first round of the repeated process, selection is based on a predefined method; otherwise the output motion vectors of Step3 of last round are used to select MBs from SW.
(3) For the first round in Step2, MF-1BT transform method will be used, for the second round in Step2 no transform will be used, which can be thought of as a special transform that has the highest precision.
(4) In Step3 of the first round, Ncand is set to 1, 16, 32, 48 respectively for different tests. Ncand is set to 1 for Step3 of the second round.
(5) It will continue to Step4 at end of Step3 of the second round. In Step4 a simple partial search method is used. Seven refMBs are checked; The SAD of the refMB with the smallest SAD value is used as threshold and compared with SAD of the best matching MB found by Step1 to 3. The MB with the smaller SAD will be the best matching MB and thus the whole block matching motion estimation process ends.

The results for two different CIF files Forman and Mobile with different Ncand settings are shown in Table 4 and Table 5 respectively. The output avg_psnr_this is the average PSNR value for 100 frames using method of this invention; avg_psnr_full is that of using full search method. avg_psnr_diff and max_psnr_diff are average and maximum PSNR difference between these two methods.

The Ncand=1 setting corresponds to conventional one step and one candidate LPDM method, which has a average PSNR drop of −2.604 and −1.787 for these two tested files when compared with results of FS method. When using this invention and set Ncand to 48, the average PSNR drop is only −0.042 and −0.001 and is improved 68 and 101 times compared with conventional one candidate method.

TABLE 4
Forman, CIF 352 × 288, 100 frames, MF-1BT

| Ncand | 1 | 16 | 32 | 48 | 64 |
|---|---|---|---|---|---|
| avg_psnr_full | 33.432 | 33.432 | 33.432 | 33.432 | 33.432 |
| avg_psnr_this | 30.828 | 33.174 | 33.336 | 33.391 | 33.401 |
| avg_psnr_diff | −2.604 | −0.259 | −0.096 | −0.042 | −0.031 |
| max_psnr_diff | −5.459 | −1.449 | −0.802 | −0.479 | −0.444 |
| Hit_rate (%) | 64.30 | 93.71 | 95.83 | 96.71 | 97.25 |

TABLE 5
Mobile, CIF 352 × 288, 100 frames, MF-1BT

| Ncand | 1 | 16 | 32 | 48 | 64 |
|---|---|---|---|---|---|
| avg_psnr_full | 23.933 | 23.933 | 23.933 | 23.933 | 23.933 |
| avg_psnr_this | 22.917 | 23.919 | 23.931 | 23.932 | 23.932 |
| avg_psnr_diff | −1.016 | −0.014 | −0.002 | −0.001 | −0.001 |
| max_psnr_diff | −1.787 | −0.303 | −0.023 | −0.023 | −0.023 |
| Hit_rate (%) | 81.31 | 98.67 | 99.18 | 99.41 | 99.53 |

Table 6 shows the some more test results using 6 different image files using this invention with Ncand set to 48. In Table 6, the average PSNR difference of all 6 video sequences is −0.016. This shows that when MF-1BT transform is used and Ncand is set to 48, the PSNR of predicted image using this invention is close to that of FS method.

TABLE 6
Ncand = 48, MF-1BT, 100 frames, CIF 352 × 288

| Image files | Bus | Flower | Mobile | Forman | Stefan | Coastguard |
|---|---|---|---|---|---|---|
| avg_psnr_full | 24.901 | 26.078 | 23.933 | 33.432 | 25.913 | 29.617 |
| avg_psnr_this | 24.877 | 26.077 | 23.932 | 33.391 | 25.897 | 29.605 |
| avg_psnr_diff | −0.024 | −0.001 | −0.001 | −0.042 | −0.016 | −0.012 |
| max_psnr_diff | −0.214 | −0.032 | −0.023 | −0.479 | −0.127 | −0.268 |
| Hit_rate (%) | 98.49 | 95.39 | 99.41 | 96.71 | 99.06 | 99.81 |

This invention provides the method to make the complexity of the method and apparatus to implement motion estimation provided by this invention scalable, by using one or more of the following methods:
Using configurable Ncand in Step2.
Using configurable transform method in Step2.
Using configurable repeated times of Step1 to Step3.
Using configurable setting of whether to do or to skip Step4.
Using configurable motion estimation method in Step4.
Using configurable setting of number of searching MB in Step4.

Some embodiment may use some or all of the available complexity scalability techniques for the motion estimation methods and apparatus provided by this invention. The embodiments can scale up to repeat the process two or more times, to set Ncand to a big value and to search more MBs in Step4. When these techniques are combined to use, motion estimation accuracy could be close to full search method. The same embodiments can be configured to skip Step4, to use one round of Step1 to 3 process and to set Ncand to 1, and will scale down to conventional LDPM method.

What is claimed is:

1. A motion estimation method for selecting the best matching micro block (MB) in search window (SW) for the current micro block (curMB), comprising the steps of:
Step1: Select all or subset of MBs from SW to form a set {refMB}. If it is the first round of the repeated process, selection is based on a predefined method; otherwise the output motion vectors of Step3 of last round are used to select MBs from SW.
Step2: Use a transform method to transform the curMB and {refMB} to simplified representations curMBt and {refMBt}.
Step3: Search in {refMBt} and find predetermined or configurable number (Ncand) of MBs that best match curMBt by using a criterion that is suitable for the transform used in Step2. Output the motion vectors of these Ncand of best matching MBs to be used for the Step1 of next round. If Ncand=1, the final one best matching MB is determined and the process ends; otherwise, make the following changes, go to Step1 and repeat the process:
(a) Use a different transform that can generate higher precision representations of curMB and {refMB} than last time, or just output the full bit-depth pixel without changing it, which can be thought of as a transform with the highest precision.
(b) Use a smaller candidates number Ncand than that used in last round.

2. The method of claim 1, further comprising of:
Step4: The sum of the absolute differences (SAD) value of the best matching MB will be compared to a threshold. If it is less than the threshold, the best-matching block is found and search process ends. Otherwise, it means Step1 to 4 fail to find the best matching micro block. Then a new round of motion estimation process other than that used in Step1 to 3 for finding the best matching MB in SW for the curMB is carried out. After the best matching block is found in the said new round of motion estimation process, the whole best block matching selecting process ends.

3. The method of claim 1, use one or more of the following method to do the transform in Step2:
The 1-bit transform (1BT) [3],
Multiplication-free 1-bit transform (MF-1BT) [5]
Multiplication-free 1-bit transform using one diamond kernel filter (MF-1BT-1 DK) [19]
Constrained 1-bit transform (C-1BT) [4]
2-bit transform2 (2BT) [6]
Weighted Constrained One-Bit Transform (WC-1BT) [16]
Truncated gray-coded bit-plane matching (T-GCBPM) [2]
Truncated bit-plane matching (T-BPM) [7][11]
Low bit-depth matching with adaptive search range (LBDM-ASR) [15][17]
LPDM with diamond search and 1BT(LBDM-DS)[18]
LPDM with early termination (LPDM-ET) [13] [14].

4. The method of claim 1, wherein the repeated times of Step1 to 3 is predefined.

5. The method of claim 1, wherein the repeated times of Step1 to 3 is configurable.

6. The method of evaluating the effectiveness of Step1 to Step3 in claim 1 of a certain transform method with different Ncand setting for a given sequence of video frames, by calculating Hit_rate for the said sequence of video frames using said transform method and Ncand setting.

7. An apparatus of evaluating the effectiveness of Step1 to Step3 in claim 1 of a certain transform method with different Ncand setting for a given sequence of video frames, by calculating Hit_rate for the said sequence of video frames using said transform method and Ncand setting.

8. The method to make the complexity of claim 1 scalable by using configurable transform method in Step2.

9. The method to make the complexity of claim 1 scalable by using configurable Ncand in Step2.

10. The method to make the complexity of claim 1 scalable by using configurable repeated times of Step1 to Step3.

11. The method to make the complexity of claim 2 scalable by using configurable motion estimation method Step4.

12. The method to make the complexity of claim 2 scalable by using configurable setting of whether to do or to skip Step4.

13. The method to make the complexity of claim 2 scalable by using configurable setting of the number of searching MBs in SW in Step4.

14. A computer-readable medium storing computer-executable program code for performing a method according to claim 1, whereby execution of the code by a processor causes the processor to select the best matching micro block in search window.

15. A computer-readable medium storing computer-executable program code for performing a method according to claim 2, whereby execution of the code by a processor causes the processor to select the best matching micro block in search window.

16. The method of claim 1, uses the following transform method in step 2: The block are filtered with a multi-bandpass filter, the filtered results are used as pixel-wise thresholds to construct simplified representation of the original block.

17. The method of claim 1, search window is composed of one block.

18. The method of claim 1, search window is composed of a plurality of different blocks.
